(19) United States
(12) Patent Application Publication
(10) Pub. No.: US 2026/0195583 A1
(43) Pub. Date: Jul. 9, 2026

(54) Distillation of Training Data for On-Device Personalized Learning for Models

(71) Applicant: Google LLC, Mountain View, CA (US)

(72) Inventors: Rui Lin, Sunnyvale, CA (US); Desmond Chun Fung Chik, Redmond, WA (US); Derek Joseph Dechen Chow, Santa Clara, CA (US)

(21) Appl. No.: 19/127,702

(22) PCT Filed: Nov. 7, 2022
(86) PCT No.: PCT/US2022/049089

§ 371 Date: May 6, 2025

(51) Int. Cl. G06N 3/08; G06N 3/0475

(52) U.S. Cl. CPC G06N 3/08; G06N 3/0475

(57) ABSTRACT

The present disclosure is directed to generating lightweight (e.g., distilled) representations of training data sets for on-device personalized learning. Distilled training examples are used as a regularizer for personalized learning. Personalized learning involves locally fine-tuning a model with user examples. The embodiments deploy of a machine learning (ML) model (e.g., a generative model) that procedurally generates training samples that closely approximates the data (probability distribution) of the training set. More specifically, the model generates a “distilled” personalized training data set to be employed locally for on-device personalized learning of a generalized trained model. Because the ML model (deployed to the model for personalized training of a target model) generates a distilled training data set, the ML model may be referred to as a training set distillation (TSD) model.

### PRIORITY CLAIM

This application is based upon and claims the right of priority under 35 U.S.C. § 371 to International Application No. PCT/US2022/049089 filed on Nov. 7, 2022. Applicant claims priority to and the benefit of this application and incorporates the application herein by reference in its entirety for all purposes.

### FIELD

The present disclosure relates generally to machine learning. More particularly, the present disclosure relates to the distillation of training data for on-device personalized learning for machine-learned models.

### BACKGROUND

Machine learning (ML) models are routinely trained and deployed on computing devices. Many models are implemented by computing devices with limited computational resources (e.g., devices with modest amounts of available memory and/or computational bandwidth). For example, many models are implemented by mobile devices (e.g., smartphones, tablets, and wearables) and internet-of-things (IoT) devices (e.g., smart speakers, smart cameras, and displays). Such devices with modest amounts of available computational resources may be loosely referred to as client (or client-like) devices. However, training a model may involve large training datasets and require significant amounts of computation. Thus, computational devices with significant amounts of available computational resources may be required to train a model. Such devices with significant amounts of computational resources may be loosely referred to as server (or server-like) devices. Once trained on a server device, the model may be ported to a client device.

After a model is trained, the models may be “fine-tuned” (or personalized) to be responsive to particular data generated by a particular user of a particular client device. This personalization (or fine-tuning) of a model may be referred to as personalized learning. Due to privacy concerns surrounding the particular data generated by the particular user of the particular client device, it may be desirable to maintain the locality of the particular data on the particular client device. That is, it may be desirable to restrict access of the particular data to the particular client and perform the personalized learning for the model on the particular client device. However, the personalized learning (or “fine-tuning” training) for the model may still require significant amounts of computational resources not available on the client device. Additionally, conventional personalized learning may result in a model that is “overfitted.” Therefore, the personalized model may not be generalizable to data outside of the personalized data that resulted in the overfitting of the personalized model.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for training a model. The method includes acquiring, at a computing device, a first set of data. Each atomic data element of the first set of data is at least partially generated by one or more sensors of the computing device and is encoded in a first representation corresponding to a first domain. For each atomic data element of the first set of data, another encoding of the atomic data element of the first set of data in a second representation corresponding to a second domain is generated at the computing device. The first function is an invertible transformation between the first domain and the second domain. An acquired distribution that characterizes the first data set in the second domain is determined at the computing device. Determining the acquired distribution may be based on the other encoding of the first set of data in the second representation. A generated set of data may be generated at the device. Each atomic data element of the generated set of data may be encoded in the second representation and may be generated by sampling the acquired distribution. A model may be trained at the computing device based on the generated set of data

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example personalized learning environment that is consistent with various embodiments;

FIG. 2 depicts a block diagram of a process for generating a distilled personalized training data set, in accordance with various embodiments;

FIG. 3A depicts a flowchart diagram of an example method for personalizing a model via generated distilled personalized training data according to example embodiments of the present disclosure;

FIG. 3B depicts a flowchart diagram of an example method for generating distilled personalized training data according to example embodiments of the present disclosure;

FIG. 4 depicts a flowchart diagram of another example method for personalizing a model via generated distilled personalized training data according to example embodiments of the present disclosure.

Reference numerals that are repeated across plural figures are intended to identify the same features in various implementations.

### DETAILED DESCRIPTION

### Overview

Generally, the present disclosure is directed to systems and methods for generating lightweight representations of training data sets. The lightweight representations can be deployed locally on a device (e.g., the device that acquired an original representation of the training data set) as a training examples generator. Training examples can be used as a regularizer for on-device (e.g., local) personalized learning to prevent overfitting and protect the privacy of the user that the model is being personalized for. Personalized learning involves locally fine-tuning the model with user examples. Conventional personalized learning may overfit the user examples causing the feature's general performance to degrade. As such, the embodiments deploy a machine learning (ML) model (e.g., a generative model) that procedurally generates training samples that closely approximates the data (probability distribution) of the training set. More specifically, the model generates a “distilled” personalized training data set to be employed locally for on-device personalized learning of a generalized trained model. Because the ML model (deployed to the model for personalized training of a target model) generates a distilled training data set, the ML model may be referred to as a training set distillation (TSD) model.

The TSD model of the embodiments may be significantly smaller in size (e.g., 10 MB) than an undistilled personalized training data set, which may easily reach sizes in excess of 100 MBs, or even tens of GBs. The embodiments may employ various generative models as the TSD model. In one non-limiting embodiment, a normalizing flow TSD model is employed. In other embodiments, a generative adversarial network (GAN) may be employed for the TSD model. However, the embodiments are not so limited, and other generative models may be employed for the TSD model.

The TSD model enables a probability distribution remapping (e.g., from a first vector space to a second vector space) technique. The distilled training samples generated by the TSD model are used as a training dataset substitute (e.g., a distilled personalized training data set) for regularizing a personalized model version of a generalized trained model. As such, the personalized model may be fine-tuned (or personalized) locally on the user's device, without sharing their personalized training data with other devices. When fine-tuned locally, the personalized model has improved performance, with respect to novel personalized input and does not suffer the degradation of general model performance. For example, the personalized model does not suffer from issues related to overfitting.

Throughout this disclosure, the term model may apply to any computable operation (e.g., a computable function) or set of computable operations (e.g., a set of computable functions) that are employable to generate detections, predictions, classifications, or the like for input data (e.g., image data, audio data, video data, textual data, or the like). For exemplary purposes only, the following discussion focusses on a non-limiting example model that is employable to detect and/or classify user gestures within video input data. However, the embodiments are not so limited, and a model may refer to any computable operation (e.g., a function) that receives input data and generates a deterministic or stochastic outcome (e.g., detections, predictions, classifications, and the like) based on the input data. In the embodiments, a model may be a layered model (e.g., a model implemented by a deep neural network).

To personalize (or customize) a layered model via personalized learning, the model's top (or latter) layers may be fine-tuned to customize the model's detections, predictions, and/or classifications for a particular user. The model may be fine-tuned with vectors from an abstract vector space. The portion of a model that is updated during personalized learning (e.g., the top or latter layers) may be referred to as the model's head or the head layers. The portion of the model that is preserved during personalized learning may be referred to as the model's backbone, backbone network, and/or backbone layers. For instance, a neural network-implemented model may be trained to detect general gestures of general users within input video data. A generalized training data set (e.g., video data) that includes examples of general gestures from a plurality of users may be used to perform the generalized training. A model that has undergone such generalized training may be referred to throughout as a generalized trained model.

After the generalized training, the model may be personalized to detect and/or classify particular gestures of a particular user. Such personalized learning (or training) may include fine-tuning the top (or latter) layers of the model (e.g., the model's head layers), such that the fine-tuned model is enabled to detect and/or classify the gestures of a particular user. A personalized training data set that includes examples of particular gestures from the particular user may be used to perform the personalized training (or personalized learning). Personalized learning may adjust and/or update the parameters (or weights) of the model's head. The personalized learning may employ embedded representations of the example particular gestures of the particular user.

Due to privacy concerns regarding the example particular gestures of the particular user, it is preferable to perform the personalized learning on the particular user's device, such that no other devices (or parties) have access to the personalized training data These scenarios typically involve training over the embedded representation. On-device personalized learning may have a few unique constraints. For instance, only a few personalized examples (e.g., 5-10) may have been collected from the user to fine-tune the model (e.g., updating the model's head). Fine-tuning with a small number of personalized examples may result in overfitting and likely performance degradation in the existing classes that the model is trained to detect (e.g., in the generalized training stage).

Some conventional personalized learning approaches employ an offline training scenario. In such conventional approaches, the generalized training data set may be combined with the personalized training data set (or examples) to ensure the model does not suffer from overfitting. Deploying these conventional techniques for on-device training may not be feasible as training sets are large, e.g. a 4 kb embedding with 100,000 samples would use up 400 mb. Thus, these conventional approaches may not be scalable when multiple models are supporting personalized learning.

Other conventional personalized learning approaches employ federated learning, as an alternative to on-device (or local) training. These conventional approaches may mitigate overfitting issues by averaging personalized weights on the server side across the population of users. However, non-local personalized training does not secure the user's privacy, as the personalized data may be uploaded to a server device. Furthermore, the objective (and end result) of federated learning is not quite the same, since the model is improved the across the population, as opposed to improving the model for a particular user.

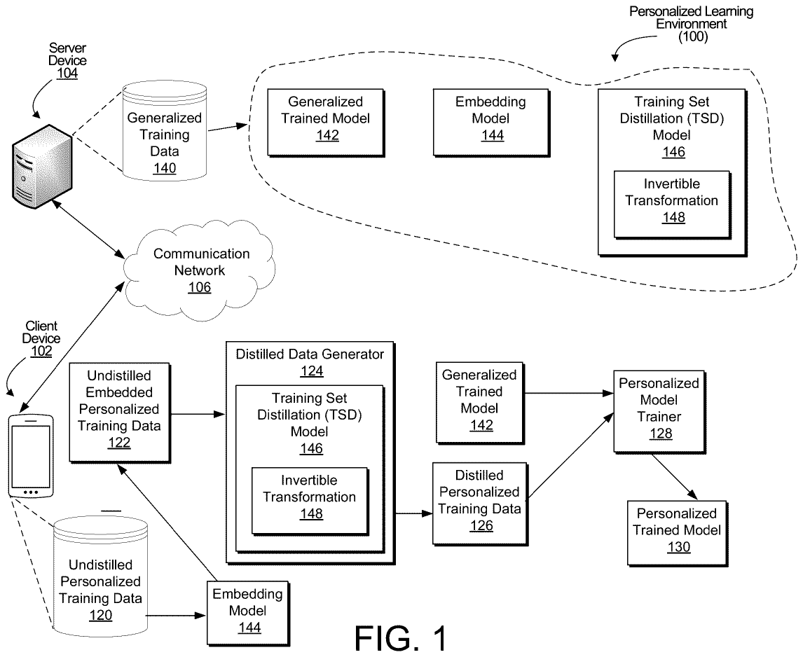

To address these inadequacies of conventional personalized learning, the embodiments are directed towards a distilled training data generator that can be deployed on-device. The distilled training generator can implement a TSD model for the generation of a distilled personalized training data set, as discussed throughout. The generation of the distilled personalized training data set is based on undistilled personalized training data acquired by the user's device. The distilled personalized training data set may further include a distillation of a larger, more generalized data set (e.g., a distillation of at least a portion of generalized training data 140 of FIG. 1). The undistilled personalized training data set may be acquired by one or more sensors of the user's device in a native data format, schema, and/or encoding. An embedding model may be employed to generate vector embeddings of the undistilled personalized training data set in a first vector space.

The vector embeddings of the undistilled personalized training data set may be transformed to a second vector space, via an invertible transformation function of the TSD model. The vector embeddings of the undistilled personalized training data set may give rise to a “well-behaved” probability (e.g., parameterizable) distribution in the second vector space. For instance, the distribution of the vector embeddings of the undistilled personalized training data in the second vector space may be a multivariate Gaussian distribution. Distilled personalized training examples (e.g., vector embeddings in the second vector space) may be generated by sampling the distribution of the vector embeddings of the undistilled personalized training data in the second vector space. The generated samples may be transformed to the first vector space via the invertible transformation function of the TSD model. The generated samples with vector embeddings in the first vector space may be employed to generate the distilled personalized training data set. The generalized trained model may be personalized on-device via the distilled personalized training data set and various personalized training (or learning) methods.

Aspects of the present disclosure provide a number of technical effects and benefits. For instance, because the personalized training data sets are distilled (and generated), the models are orders of magnitude smaller in size (5-10 MB), making on-device deployment feasible compared to the GBs of server training data. Moreover, the distillation of the personalized training data significantly prevents overfitting that may occur with personalized learning. Additionally, because the personalized learning is carried out as on-device (or local) training, the user's data privacy is maintained.

### Example Devices and Systems

FIG. 1 depicts a block diagram of an example personalized learning environment 100 that is consistent with various embodiments. The environment 100 may be employed to enable on-device personalized learning for machine-learned models, via the distillation of a personalized training data set. Environment 100 includes a client device 102 and a server device 104. The client device and the server device 104 are communicatively coupled via a communication network 106.

The server device may have access to a set of generalized training data 140. The server device 104 may employ the generalized training data 140 to at least partially enable a generation and/or training of at least one of a generalized trained model 142. an embedding model 144, and a training set distillation (TSD) model 146. The generalized training data 140 may include image data, audio data, video data, textual data, or the like. Each atomic data element (e.g., a discrete element) of the generalized training data 140 may be labeled with a ground truth with respect to a detection, prediction, classification, or the like associated with the atomic data element. The generalized training data 140 may have been aggregated from a plurality of users and/or a plurality of client devices.

Throughout this disclosure, the term model (e.g., a model implemented in the generalized trained model 142) may apply to any model that is employable to generate detections, predictions, classifications, or the like for input data (e.g., image data, audio data, video data, textual data, or the like). For exemplary purposes only, the following discussion focusses on a non-limiting example model that is employable to detect and/or classify user gestures within video input data. However, the embodiments are not so limited, and a model may refer to any model that receives input data and generates a deterministic or stochastic) outcome (e.g., detections, predictions, classifications, and the like) based on the input data. In the embodiments, a model may be a layered model (e.g., a model implemented by a deep neural network. The model may include backbone layers and head layers.

As noted above, in a non-limiting example embodiment, the generalized trained model 142 may be a model that detects and/or classifies user gestures depicted within video input data. A video clip depicting a user gesture may be referred to as an atomic data element. As such, the generalized training data 140 may include video data (e.g., a set of discrete video clips) depicting users performing various gestures. Each atomic data element (e.g., a discrete video clip) of the generalized training data 140 may depict a user performing a gesture. Each atomic data element may include a label that indicates a ground truth for a classification of the gesture depicted in the video clip. The generalized training data 140 may be employed to train at least the backbone layers of the generalized trained model 142. In some embodiments, the generalized training data 140 may be employed to train at least a portion of the head layers of the generalized trained model 142. As discussed further below, the generalized trained model 142 may be personalized, via the training and/or updating of the head layers of the generalized trained model 142. A personalized version of the generalized trained model 142 is depicted in FIG. 1 as the personalized trained model 130.

The embedding model 144 may be enabled to generate a vector embedding of input data. The generated vector embedding may be an embedding within a first vector space. The generated vector embedding may serve as an input to the generalized trained model 142. For example, the vector embedding of a video clip may be fed in as input to the generalized trained model 142. Thus, a preprocessor of the generalized trained model 142 may employ the embedding model 144 to generate a vector embedding of an input video clip, so that the generalized trained model 142 may generate an outcome (e.g., a classification) of the video clip. Because the generalized trained model 142 expects an input of a vector within the first vector space, the first vector space may be referred to as a first domain.

Details of the TSD model 146 are discussed throughout. The TSD model 146 of the embodiments may be significantly smaller in size (e.g., 10 MB) than an undistilled personalized training data set (e.g., the undistilled personalized training data 120 and/or the corresponding undistilled embedded personalized training data 122. The embodiments may employ various generative models as the TSD model 146. In one non-limiting embodiment, a normalizing flow-based TSD model 146 is employed. In other embodiments, a generative adversarial network (GAN) may be employed for the TSD model 146. However, the embodiments are not so limited, and other generative models may be employed for the TSD model 146. Via the communication network 106, the server device 104 may provide each of the generalized trained model 142, the embedding model 144, and the TSD model 146 to the client device 102.

The TSD model 146 may include an invertible transformation 148. The invertible transformation 148 may be a transformation between the first vector space and the second vector space. That is, the invertible transformation 148 may transform a vector embedding in the first vector space to a corresponding vector embedding in a second vector space. Because the transformation is an invertible transformation, the invertible transformation 148 may be employed to transform a vector embedding in the second vector space to a corresponding vector embedding in the first vector space. Note that the first and second vector spaces may be, but need not be, of similar dimensions. Because the first vector space may be referred to as a first domain, the second vector space may be referred to as a second domain.

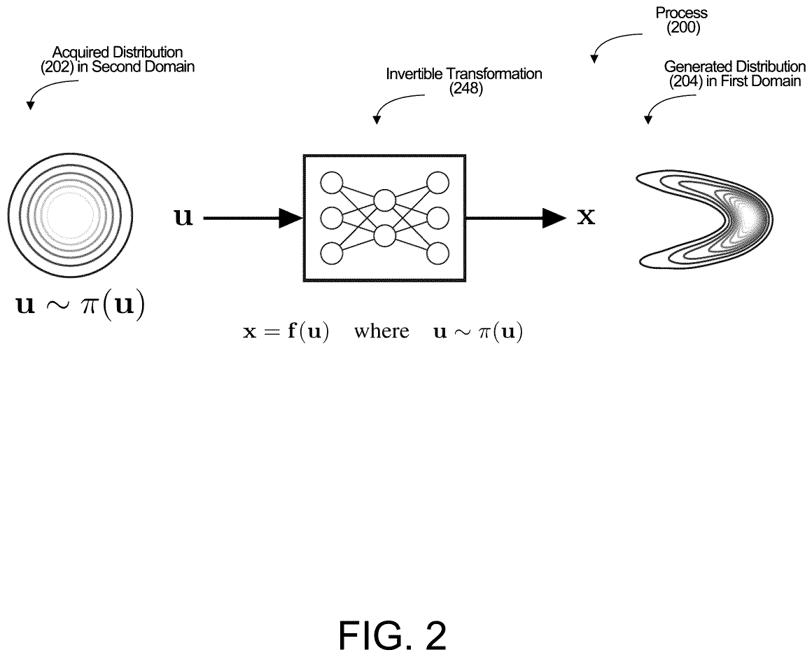

Via the invertible transformation 148, the TSD model 146 enables a probability distribution remapping (e.g., from a first vector space to a second vector space) technique. This remapping is discussed in conjunction with at least FIG. 2. However briefly here, the remapping can transform a multivariate Gaussian distribution (e.g., in the second domain) to a target (or acquired) distribution in the first domain (and vice-versa). The TSD model 146 (and hence the invertible transformation 148) may be trained using log-likelihood loss functions in the target distribution (e.g., in the first domain) to the Gaussian distribution (e.g., in the second domain).

The distilled training samples generated by the TSD model 146 are used as a training dataset substitute (e.g., distilled personalized training data 126) for regularizing a personalized model version (e.g., personalized trained model 130 of the generalized trained model 142. As such, the personalized trained model 130 may be fine-tuned (or personalized) locally on the client device 102, without sharing the personalized training data (e.g., the undistilled personalized training data 120, the undistilled embedded personalized training data 122, and/or the distilled personalized training data 126) with other devices. When fine-tuned locally, the personalized trained model 130 has improved performance, with respect to novel personalized input and does not suffer the degradation of generalized trained model's 142 performance. For example, the personalized trained model 130 does not suffer from issues related to overfitting

More specifically, a user of the client device 102 (e.g., a particular user) may wish to personalize the generalized trained model 142 for their own purposes. That is, the user may wish to perform personalized learning on the generalized trained model 142, to generate the personalized trained model 130. For instance, in the non-limiting example embodiment of gesture detection and/or classification, a particular user may wish to personalize the generalized trained model 142 to detect and/or classify their particular gestures. To such ends, the particular user may employ one or more sensors (e.g., one or more cameras and/or one or more microphones) of the client device 102 to acquire, generate, and/or capture video data depicting their particular gestures. Such video clips may be aggregated in the undistilled personalized training data 120. Thus, the client device 102 may acquire undistilled personalized training data 120. In a non-limiting embodiment, video clips (e.g., acquired via one or more cameras of the client device 102) in the undistilled personalized training data 120 may depict the particular user's particular gestures. The undistilled personalized training data 120 may be raw data, in that the undistilled personalized training data 120 is in its native data format (e.g., video data, image data, audio data, or the like). That is, the undistilled personalized training data 120 may be encoded in its native representation and not in a vector embedding representation (or encoding).

As noted throughout, at least for privacy reasons, the particular user may wish to perform the personalized learning to fine-tune (or personalize) the generalized trained model 142 locally (e.g., on-device, meaning locally on client device 102) such that the training data unique to them is not transmitted off-device and/or away from client device 102. Personalizing the generalized trained model 142 may include updating and/or fine-tuning the head layers of the generalized trained model 142. Also, as noted throughout, due to problems of overfitting and computational resources available on-device (e.g., on client device 102), it is desirable to generate distilled personalized training data 126 from the undistilled personalized training data 120. That is, rather than performing the personalized learning for the generalized trained model 142 via the undistilled personalized training data 120, the embodiments generate and employ the distilled personalized training data 126 for personalized learning purposes.

To such ends, the client device may implement a distilled data generator 124. The distilled data generator 124 may include the TSD model 146 (and the invertible transformation 148), provided by the server device 104. The operations of the distilled data generator 124 are discussed at least in conjunction with FIG. 2. However, briefly here, the distilled data generator 124 generates a distilled personalized training data 126. The distilled personalized training data 126 may be significantly smaller than the undistilled personalized training data 120. The client device 102 may implement a personalized model trainer 128 that employs the distilled personalized training data 126 to personalize the generalized trained model 142 to detect and/or classify the particular gestures of the particular user. The personalized learning generates a personalized trained model 130, via the distilled personalizes training data 126 and one or more learning methods implemented by the personalized model trainer 128. The personalized learning occurs locally (e.g., on the client device 102) such that no other computing devices (e.g., the server device 104) has access to the undistilled personalized training data 120, nor the distilled personalized training data 126.

In various embodiments, the undistilled personalized training data 120 is fed into the embedding model (e.g., implemented by the client device 102) to generated undistilled embedding personalized training data 122. Each atomic data element of the undistilled embedding personalized training data 122 includes a vector embedding of a corresponding atomic data element of the undistilled personalized training data 120 (e.g., a discrete video clip depicting a particular gesture performed by the particular user). The vector embedding of the video clip may be in the first vector space (or first domain). The undistilled embedded personalized training data 122 is fed into the distilled data generator 124. The distilled data generator 124 generates the distilled personalized training data 126. Each atomic data element of the distilled personalized training data 126 may be a vector embedding (e.g., in the first vector space or first domain) of generated and distilled data. Note that the atomic data elements of the distilled personalized training data 126 may be generated, and thus not elements of the undistilled personalized training data 120 and/or the undistilled embedded personalized training data 122. The generation of the distilled personalized training data 126 is discussed at least in conjunction with FIG. 2.

FIG. 2 depicts a block diagram of a process 200 for generating a distilled personalized training data set. The block diagram of FIG. 2 shows an acquired distribution 202 and a generated distribution 204. The acquired distribution 202 may be a probability distribution over the first vector space (or the first domain). The generated distribution 204 may be a probability distribution over the second vector space (or the second domain). An invertible transformation 248 may be employed to transform points, vectors, distributions, tensors, or geometrical objects between the first vector space (or the first domain) and the second vector space (or the second domain). The invertible transformation 248 may be equivalent (or at least similar to) the invertible transformation 148 (of FIG. 1) of the training set distillation (TSD) model 146. Accordingly, the distilled data generator 124 (of FIG. 1) may implement the invertible transformation 248 on the client device (of FIG. 1).

In at least the one embodiment shown in FIG. 2, the invertible transformation 248 is represented by the function x=f(u), where u is a vector embedding in the second vector space and x is a vector embedding in the first vector space. Thus, the invertible transformation 248 is a mapping from the second vector space to the first vector space. The inverse representation of the invertible transformation 248 is: u=f⁻¹(x) and is a mapping from the first vector space to the second vector space. In various embodiments, the undistilled embedded personalized training data 122 may be employed to generate and/or determine the acquired distribution 202 in the second domain. In such embodiments, each atomic data element of the undistilled embedded personalized training data 122 is transformed to the second vector space via: f⁻¹(x) to generate the acquired distribution 202 in the second vector space. The acquired distribution 202 in the second vector space may be generated by parameterizing the transformed points of the undistilled embedded personalized training data 122. For instance, the acquired distribution may be a parameterized multivariate Gaussian.

The generated distribution 204 in the first vector space may be generated by sampling the acquired distribution 202 in the first vector space. Each sampled point may be represented by π(u). Each sampled point in the second vector space may be transformed to the first vector space via the invertible transformation 248, e.g., f(π(u))

### Example Methods

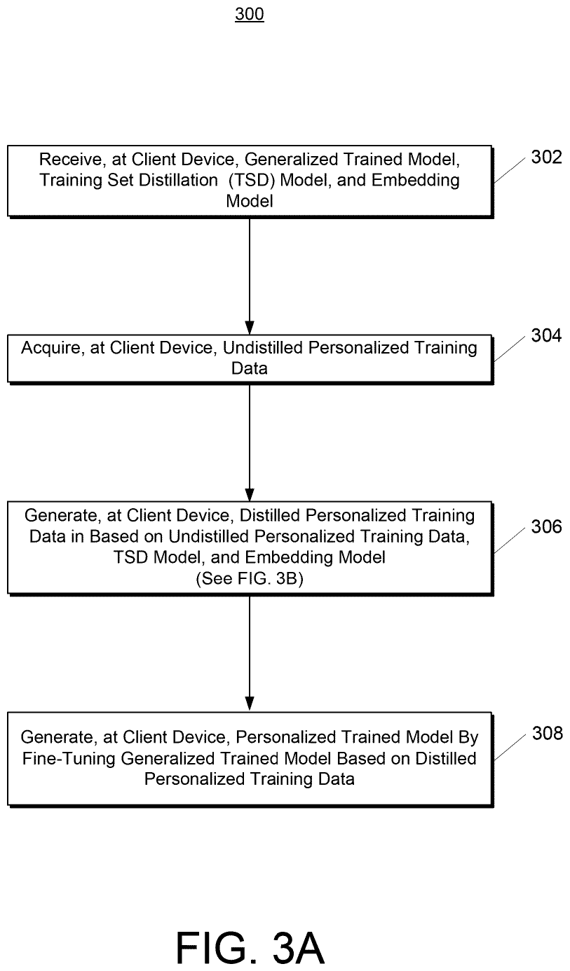

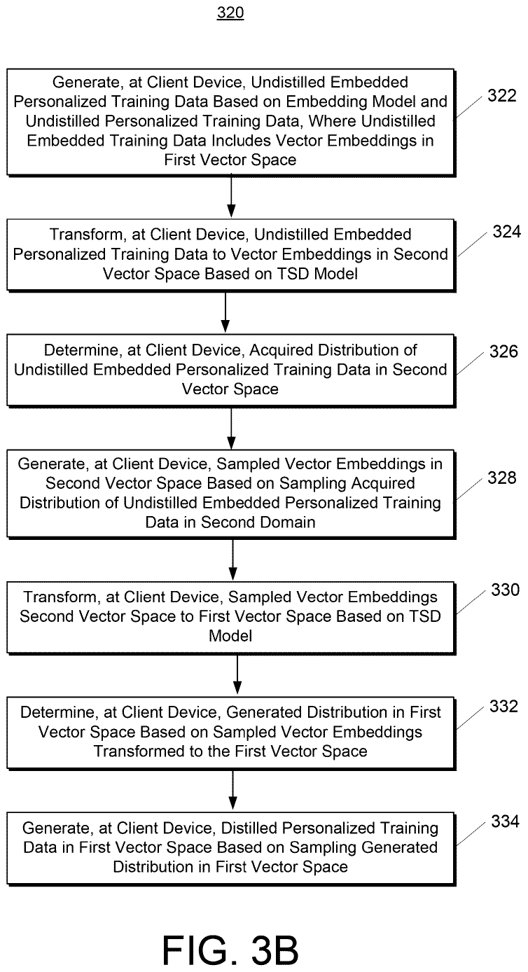

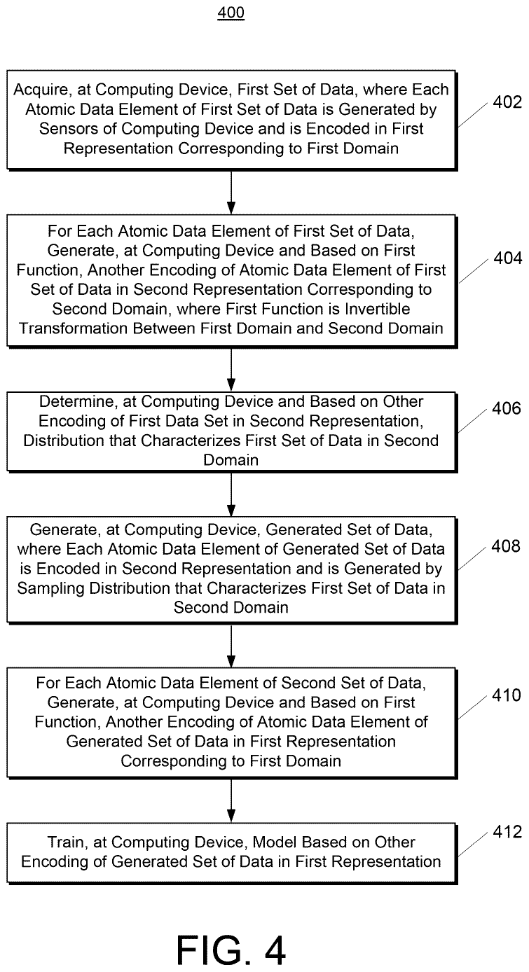

FIGS. 3A-4 depict flowcharts for various methods implemented by the embodiments. Although the flowcharts of FIGS. 3A-4 depict steps performed in a particular order for purposes of illustration and discussion, the methods of the present disclosure are not limited to the particularly illustrated order or arrangement. Various steps of the methods of FIGS. 3A-4 can be omitted, rearranged, combined, and/or adapted in various ways without deviating from the scope of the present disclosure. A distilled data generator (e.g., distilled data generator 124 of FIG. 1) and/or personalized model trainer (e.g., personalized model trainer 128 of FIG. 1) may perform at least some steps in various methods.

FIG. 3A depicts a flowchart diagram of an example method 300 for personalizing a model via generated distilled personalized training data according to example embodiments of the present disclosure. Method 300 begins at block 302, where at least one of a generalized trained model (e.g., generalized trained model 142 of FIG. 1), a training set distillation (TSD) model (e.g., TSD model 146 of FIG. 1), and an embedding model (e.g., embedding model 144 of FIG. 1) may be received at a client device (e.g., client device 102 of FIG. 1). At block 304, undistilled personalized training data (e.g., undistilled personalized training data 120 of FIG. 1) may be acquired at the client device. The undistilled personalized training data may be acquired via one or more sensors of the client device. The undistilled personalized training data may in a native data format and/or schema.

At block 306, distilled personalized training data (e.g., distilled personalized training data 126 of FIG. 1) may be generated at the client device. Various embodiments of generating distilled personalized training data are discussed in conjunction with method 320 of FIG. 3B. However, briefly here, generating the distilled personalized training data may be based on at least one of the undistilled personalized training data, the TSD model, and the embedding model. A distilled data generator (e.g., distilled data generator 124 of FIG. 1) that is implemented by the client device may be employed to generate the distilled personalized training data. At block 308, a personalized trained model (e.g., personalized trained model 130) may be generated at the client device. Generating the personalized trained model may be based on employing the distilled personalized training data to fine-tune the generalized trained model via one or more personalized learning techniques. Generating the personalized trained model may include fine-tuning (or updating) the head layers of the generalized trained model.

FIG. 3B depicts a flowchart diagram of an example method 320 for generating distilled personalized training data according to example embodiments of the present disclosure. Method 320 begins at block 322, where undistilled embedded personalized training data (e.g., undistilled embedded personalized training data 122 of FIG. 1) is generated at a client device (e.g., client device 102 of FIG. 1). Generating the undistilled personalized training data may be based on an embedding model (e.g., embedding model 144 of FIG. 1) and undistilled personalized training data (e.g., undistilled personalized training data 120 of FIG. 1) in a native data format. Each atomic data element of the undistilled embedded personalized training data may include a vector embedding of a corresponding atomic data element of the undistilled personalized training data in the native data format. The vector embedding of each atomic data element may be in a first vector space (or a first domain.

At block 324, the vector embeddings of the atomic data elements of the undistilled embedded personalized training data may be transformed from the first vector space to a second vector space (or a second domain). Transforming the vector embeddings from the first vector space to the second vector space may be based on a training set distillation (TSD) model (e.g., TSD model 146 of FIG. 1). In at least one embodiment, transforming the vector embeddings from the first vector space to the second vector space may be based on an invertible transformation (e.g., invertible transformation 148 of FIG. 1 and/or invertible transformation 248 of FIG. 2) implemented by the TSD model.

At block 326, an acquired distribution (e.g., acquired distribution 202 of FIG. 2) of the embedded personalized training data in the second vector space may be determined at the client device. The acquired distribution of the embedded personalized training data in the second vector space may be an acquired distribution because the distribution is based on the personalized training data that was acquired via sensors of the client device. In some embodiments, the acquired distribution may be determined based on determining (e.g., fitting) one or more parameters of a parameterized probability distribution. In at least one embodiment, the probability distribution is a multivariate Gaussian (or normal) distribution.

At block 328, sampled vector embeddings in the second vector space are generated at the client device. Generating the sampled vector embeddings in the second vector space may be based on sampling the acquired distribution of the undistilled embedded personalized training data in the second domain, as indicating as π(u) in FIG. 2.

At block 330, at the client device, transforming the sampled vector embeddings in the second vector space to the first vector space via the TSD model. In at least one embodiment, the sampled vector embeddings may be transformed from the second vector space to the first vector space via the invertible transformation (e.g., x=f(u) in FIG. 2). At block 332, a generated distribution (e.g., generated distribution 204) in the first vector space is determined at the client device. Determining the generated distribution in the first vector space may be based on the sampled vector embeddings transformed to the first vector space. At block 334, distilled personalized training data (e.g., distilled personalized training data 126 of FIG. 1) in the first vector space may be generated at the client device. In at least one embodiment, generating the distilled personalized training data may be based on sampling the generated distribution in the first vector space. In at least one embodiment generating the distilled personalized training data may be based directly on the sampled vector embeddings transformed from the second vector space to the first vector space.

FIG. 4 depicts a flowchart diagram of another example method 400 for personalizing a model via generated distilled personalized training data according to example embodiments of the present disclosure. Method 400 begins at block 402, where a first set of data (e.g., undistilled personalized training data 120 and/or undistilled embedded personalized training data 122 of FIG. 1) is acquired at a computing device (e.g., client device 102 of FIG. 1). Each atomic data element (e.g., e.g., a discrete video clip depicting a user gesture) of the first set of data may be at least partially generated by one or more sensors (e.g., cameras and/or microphones) of the computing device. The first set of data may be encoded in a first representation (e.g., a first vector embedding) corresponding to a first domain (e.g., a first vector space).

At block 404, for each atomic data element of the first set of data, another encoding of the atomic data element of the first set of data may be generated at the computing device. Generating the other encoding of the atomic data element of the first set of data may be based on a first function. The other encoding of the atomic data element of the first set of data may be in a second representation (e.g., a second vector embedding) corresponding to a second domain (e.g., a second vector space). The first function may be an invertible transformation (e.g., the invertible transformation 148 of FIG. 1 and/or the invertible transformation 248 of FIG. 2) between the first domain and the second domain.

At block 406, a distribution that characterizes the first data set in the second domain (e.g., the acquired distribution 202 of FIG. 2) may be generated at the computing device. Generating the distribution that characterizes the first data set in the second domain may be based on the other encoding of each atomic data element of the first data set in the second representation.

At block 408, a generated set of data may be generated at the computing device. Each atomic data element of the generated set of data may be encoded in the second representation (e.g., a vector embedding in the second domain). Each atomic data element of the generated set of data may be generated based on sampling the distribution that characterizes the first set of data in the second domain.

At block 410, for each atomic data element of the generated set of data, another encoding of the atomic data element of the generated set of data may be generated at the computing device. The other encoding of the atomic data element of the generated set of data may be in the first representation corresponding to the first domain. For instant, the other encoding in the first representation may be a vector embedding in the first domain. Generating the other encoding of the atomic data element of the generated set of data may be based on the first function. Distilled personalized training data (e.g., distilled personalized training data 126 of FIG. 1) may be generated based on the other encoding of the generated set of data. For example, a generated distribution (e.g., generated distribution 204 in the first domain of FIG. 2) may be generated may be generated based on the other encoding of the generated set of data. The distilled personalized training data may be generated based on sampling the generated distribution in the first domain.

At block 412, a model may be trained at the computing device. Training the model may be based on the other encoding of the generated set of data in the first representation. For instance, training the model may be based on the distilled personalized training data. Training the model may include fine-tuning or personalizing a generalized trained model (e.g., generalized trained model 142 of FIG. 1). Training the model may include generating a personalized trained model (e.g., personalized trained model 130 of FIG. 1). In at least one embodiment, training the model at block 412 may include fine-tuning the head layers of the generalized trained model.

### Additional Disclosure

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for training a model, the method comprising:
acquiring, at a computing device, a first set of data, wherein each atomic data element of the first set of data is at least partially generated by one or more sensors of the computing device and is encoded in a first representation corresponding to a first domain;
for each atomic data element of the first set of data, generating, at the computing device and based on a first function, another encoding of the atomic data element of the first set of data in a second representation corresponding to a second domain, wherein the first function is an invertible transformation between the first domain and the second domain;
determining, at the computing device and based on the other encoding of the first set of data in the second representation, an acquired distribution that characterizes the first set of data in the second domain;
generating, at the computing device, a generated set of data, wherein each atomic data element of the generated set of data is encoded in the second representation and is generated by sampling the acquired distribution; and
training, at the computing device, a model based on the generated set of data.

2. The method of claim 1, wherein acquiring the first set of data comprises:
operating the one or more sensors of the computing device to generate a native encoding of each atomic data element of the first set of data that is in a third representation corresponding to a native data domain of the one or more sensors; and
for each atomic data element of the first set of data, generating, at the computing device, the encoding of the atomic data element of the first set of data that is in the first representation based on a second function that is a transformation between the native data domain and the first domain.

3. The method of any of claims 1-2, wherein a size of the first set of data is larger than a size of the second set of data.

4. The method of any of claims 1-3, wherein the invertible transformation is implemented via a generative model.

5. The method of claim 4, wherein the generative model has been trained by a normalizing flow process.

6. The method of claim, 4, wherein the generative model is implemented by a generative adversarial network (GAN).

7. The method of any of claims 1-6, further comprising:
for each atomic data element of the generated set of data, generating, at the computing device and based on the first function, another encoding of the atomic data element of the generated set of data in the first representation corresponding to the first domain; and
training, at the computing device, the model based on the other encoding of the generated set of data in the first representation.

8. The method of claim 7, wherein generating the other encoding of the atomic data element of the generated set of data in the first representation comprises:
transforming each atomic data element of the generated set of data encoded in the second representation to the first domain based on the invertible transformation, such that the transformed atomic data element is encoded in the first representation.

9. The method of any of claims 1-8, further comprising:
determining, at the computing device, a generated distribution that characterizes the generated set of data in the first domain based on the sampling of the acquired distribution; and
generating, at the computing device, the generated set of data based on the generated distribution.

10. The method of any of claims 1-9, wherein the acquired distribution is a multivariate Gaussian distribution over the second domain.

11. A computing device, comprising:
one or more sensors;
one or more processors; and
one or more non-transitory computer-readable media that, when executed by the one or more processors, cause the computing device to perform operations, the operations comprising:
acquiring, at the computing device, a first set of data, wherein each atomic data element of the first set of data is at least partially generated by the one or more sensors of the computing device and is encoded in a first representation corresponding to a first domain;
for each atomic data element of the first set of data, generating, at the computing device and based on a first function, another encoding of the atomic data element of the first set of data in a second representation corresponding to a second domain, wherein the first function is an invertible transformation between the first domain and the second domain;
determining, at the computing device and based on the other encoding of the first set of data in the second representation, an acquired distribution that characterizes the first set of data in the second domain;
generating, at the computing device, a generated set of data, wherein each atomic data element of the generated set of data is encoded in the second representation and is generated by sampling the acquired distribution; and
training, at the computing device, a model based on the generated set of data.

12. The computing device of claim 11, wherein acquiring the first set of data comprises:
operating the one or more sensors of the computing device to generate a native encoding of each atomic data element of the first set of data that is in a third representation corresponding to a native data domain of the one or more sensors; and
for each atomic data element of the first set of data, generating, at the computing device, the encoding of the atomic data element of the first set of data that is in the first representation based on a second function that is a transformation between the native data domain and the first domain.

13. The computing device of any of claims 11-12, wherein a size of the first set of data is larger than a size of the second set of data.

14. The computing device of any of claims 11-13, wherein the invertible transformation is implemented via a generative model.

15. The computing device of claim 14, wherein the generative model has been trained by a normalizing flow process.

16. The computing device of claim 14, wherein the generative model is implemented by a generative adversarial network (GAN).

17. The computing device of any of claims 11-16, wherein the operations further comprise:
for each atomic data element of the generated set of data, generating, at the computing device and based on the first function, another encoding of the atomic data element of the generated set of data in the first representation corresponding to the first domain; and
training, at the computing device, the model based on the other encoding of the generated set of data in the first representation.

18. The computing device of claim 17, wherein generating the other encoding of the atomic data element of the generated set of data in the first representation comprises:
transforming each atomic data element of the generated set of data encoded in the second representation to the first domain based on the invertible transformation, such that the transformed atomic data element is encoded in the first representation.

19. One or more tangible non-transitory computer-readable media storing computer-readable instructions that when executed by one or more processors cause the one or more processors to perform operations, the operations comprising:
acquiring, at a computing device, a first set of data, wherein each atomic data element of the first set of data is at least partially generated by one or more sensors of the computing device and is encoded in a first representation corresponding to a first domain;
for each atomic data element of the first set of data, generating, at the computing device and based on a first function, another encoding of the atomic data element of the first set of data in a second representation corresponding to a second domain, wherein the first function is an invertible transformation between the first domain and the second domain;
determining, at the computing device and based on the other encoding of the first set of data in the second representation, an acquired distribution that characterizes the first set of data in the second domain;
generating, at the computing device, a generated set of data, wherein each atomic data element of the generated set of data is encoded in the second representation and is generated by sampling the acquired distribution; and
training, at the computing device, a model based on the generated set of data.

20. The one or more tangible non-transitory computer-readable media of claim 19, the operations further comprising:
determining, at the computing device, a generated distribution that characterizes the generated set of data in the first domain based on the sampling of the acquired distribution; and
generating, at the computing device, the generated set of data based on the generated distribution.
